(19) United States
(12) Patent Application Publication
(10) Pub. No.: US 2026/0028040 A1
(43) Pub. Date: Jan. 29, 2026

(54) LOCAL PLANNING FOR AUTONOMOUS VEHICLES USING MULTIPLE CAMERAS

(71) Applicants: Constructor Technology AG, Schaffhausen (CH); Constructor Education and Research Genossenschaft, Schaffhausen (CH)

(72) Inventors: Aleksandr Buyval, Bremen (DE); Ruslan Mustafin, Tbilisi (GE); Maksim Liubimov, Belgrade (RS); Ilya Shimchik, Costa del Sol (SG); Serg Bell, Costa del Sol (SG); Stanislav Protasov, Singapore (SG); Nikolay Dobrovolskiy, Istanbul (TR); Laurent Dedenis, Singapore (SG)

(21) Appl. No.: 18/784,071

(22) Filed: Jul. 25, 2024

(51) Int. Cl. B60W 60/00; G01C 21/36; G06V 10/82; G06V 20/56

(52) U.S. Cl. CPC B60W 60/001; G01C 21/3602; G06V 10/82; G06V 20/56; B60W 2420/403; B60W 2756/00

(57) ABSTRACT

Systems and methods for autonomous-vehicle navigation integrating path planning with a perception network. A Bird's Eye View costmap is generated at runtime using only onboard sensors. No external localization providers are used.

### TECHNICAL FIELD

The present invention relates to the field of autonomous vehicles and intelligent transportation systems, and specifically, the localization of vehicles in an environment.

### BACKGROUND

Path-planning in the context of autonomous vehicles presents a number of technical problems. For example, Model Predictive Path Integral (MPPI) control is a sample-based optimization method that rolls out numerous possible trajectories, estimates their costs, and calculates the best trajectory from among the possible trajectories. MPPI operates by repeatedly optimizing a control trajectory to minimize a cost function, taking into account a predictive model of the system and its future states. MPPI combines the advantages of model predictive control and stochastic optimization, making it suitable for tasks with complex dynamics and uncertainty. MPPI has found applications in areas such as robotic motion planning, autonomous vehicles, and reinforcement learning. Typical MPPI costs include track costs, which depend on the car's position.

One of the core components that define operational success of path planning is a costmap. A costmap is a function that takes a spatial agent location as an input and outputs a set of penalties or rewards that an agent will collect if it were to navigate to that spatial location. When working with a costmap, there are two main approaches. A costmap may be pre-generated and fed at runtime. Or, a costmap may be built on the fly. The main weakness of pre-generated costmaps is that a precise location is required to accurately localize an agent within a known costmap. Generating a precise location requires specialized hardware, such as GNSS-RTK systems. Requiring such hardware for path-planning control is not desirable for general racing applications. The technical requirements and expense of installing such equipment at racetracks makes its widespread adoption unlikely.

Methods that use precise external positioning devices suffer from various drawbacks. GPS is a relatively inexpensive positioning provider but it suffers from low accuracy (+/−1 to 3 meters) and is often susceptible to performance degradation in low coverage areas. VICON is a mostly in-door tracking system which is capable of returning precise position, but does not scale well to the dimensions of a racing track. GNSS-RTK is a GPS-based device that uses a separate base station and accelerometer sensors to provide corrections to the GPS-based position. GNSS-RTK can provide precise enough position with minimal delay in a racing scenario but it also suffers from low coverage areas and requires installation of additional hardware, such as a base station in track facilities and an on-board receiver.

LiDAR is an on-board sensor capable of generating point clouds of the surrounding environment. Each point in a point cloud is a precise measurement of distance from the LiDAR position to an object in the track. In order to use a LiDAR-based localization method, it is necessary to build an HD LiDAR map first by driving around a track with a LiDAR-enabled vehicle and recording all point clouds. Having done that, it will be possible to use a pre-built map to match a current point cloud against and to understand precise localization within the pre-built map. However, LiDAR imposes high costs and its implementation requires extensive manual tuning. Once built, the maps must be maintained and updated. Further, LiDAR is mainly used for city driving scenarios because salient environmental features are required to generate reliable matches. In a race track scenario, there may be not enough environmental features to reliably localize within a given map. Improved systems and methods are needed that overcome these limitations.

### SUMMARY

Systems and methods are disclosed for autonomous vehicle navigation without reliance on an external localization device, such as GPS or other systems external to the autonomous vehicle. In an embodiment, image data is collected along a path with an onboard camera operably coupled to an autonomous vehicle in motion. A slice of collected image data is encoded with a first neural network feature extractor and the encoded image data is passed to a Bird's Eye View (BEV) generation module. The BEV module is a second neural network that cross-correlates input features with spatial positions around the autonomous vehicle. The encoded image data is transformed into a BEV costmap, which is passed to a path-planning module operably coupled to the autonomous vehicle. The path-planning module is configured to calculate a plurality of possible paths using a cost model and selects the lowest cost path from among the possible calculated paths.

In alternative embodiments, the first neural network is a convolutional neural network and the second neural network is a pre-trained transformer. The path-planning module may comprise a Model Predictive Path Integral (MPPI) module. Selecting the lowest cost path may include applying an optimizer using a Monte Carlo approximation. In an embodiment, the second neural network is a spatial-cross attention transformer and the output of the spatial cross-attention transformer comprises a BEV feature vector.

An exemplary system for navigating a path by an autonomous vehicle in motion without using an external localization device comprises an autonomous vehicle coupled with a plurality of onboard sensors for collecting image data. A microprocessor coupled with a nontransitory storage medium is communicatively linked with the plurality of onboard sensors. A first neural network comprising a feature extractor, under program control of the microprocessor, is configured for encoding collected image data from the plurality of onboard sensors. A Bird's Eye View (BEV) generation module, under program control of the microprocessor, comprises a second neural network configured to cross-correlate input features with spatial positions around the autonomous vehicle. The BEV module is configured to transform the encoded collected image data into a BEV costmap. A path-planning module, under program control of the microprocessor, is configured to calculate a plurality of possible paths from the BEV costmap using a cost model. The path-planning module is also configured to select the lowest cost path from among the possible calculated paths.

Alternative embodiments of the system are similar to those described above. For example, the first neural network may be a convolutional neural network and the second neural network may be a pre-trained transformer. The path-planning module may be a Model Predictive Path Integral (MPPI) module. Alternatively, the second neural network can be a spatial-cross attention transformer configured to output a BEV feature vector. The BEV feature vector can be converted to a BEV costmap and passed to the path-planning controller.

### BRIEF DESCRIPTION OF THE DRAWINGS

FIG. 1 is a block diagram of a system in accordance with an embodiment.

FIG. 2 shows an embodiment of a system including a perception network and a path-planning controller.

FIG. 3 shows an embodiment of a system using path planning according to an embodiment.

FIG. 4 shows an embodiment of a system with an autonomous vehicle under path-planning control.

FIG. 5 is a flow diagram of an exemplary method according to an embodiment.

### DETAILED DESCRIPTION

Systems and methods are disclosed for integrating path planning with a perception network. A costmap is generated at runtime using only onboard sensors. No external localization providers are used. During runtime, the system tracks a queue of past camera frames. A slice of N past frames is encoded with a feature extractor, such as used with a convolutional neural network (CNN), and submitted as an input to the Bird's Eye View (BEV) generation module. The BEV generation module is a transformer-based neural network that cross-correlates input features with spatial positions around the agent. By using a deformable spatial cross-attention mechanism, the BEV generation module is able to efficiently transform information from a camera-centered coordinate frame into a top-down BEV costmap.

The provided output BEV costmap is then sent to a path-planning module, which uses that information in order to plan future trajectory. The future trajectory is executed by a vehicle agent. The vehicle agent's position is updated and the costmap-generation cycle repeats again with updated sensor information.

In an embodiment, path planning is carried out by MPPI, which is a sampling-based model predictive control algorithm. The cost function for MPPI is a quadratic function of the state and control variables. The cost function is used to minimize the distance to the desired state, the velocity, and the distance to obstacles. MPPI can optimize cost functions that are hard to approximate as quadratic functions along nominal trajectories. The input of the cost function is the state of the system. The output of the cost function is a scalar value that represents the cost of a given state. The cost function is used to evaluate different states and choose the one with the lowest cost.

Path planning in general, and MPPI in particular, is used to control autonomous vehicles by generating a trajectory that minimizes a cost function. Trajectories and costs are related. The cost of a trajectory is a function of the states visited by the trajectory. The goal of trajectory optimization is to find a trajectory that minimizes the cost. Thus, the cost function can be used to evaluate the quality of a trajectory.

The output of the path-planning controller comprises control signals. Control signals are a function of the state of the system, the control costs, and noise. The control signals are calculated using an iterative algorithm that takes into account the uncertainty in system dynamics. The first control input from the sequence of control signals is sent to one or more actuators of the autonomous vehicle. After that, the path-planning controller receives state feedback and iterations can repeat. In embodiments, other non-iterative types of algorithms or functions can be used, including recursive functions for a single vehicle.

Iteration refers to the process of repeatedly running the path-planning algorithm to improve the control policy. The path-planning algorithm works by first predicting the future state of the system based on the current state and a set of control inputs. Then, the algorithm computes a cost function that measures how well the predicted state matches the desired state. Finally, the algorithm updates the control inputs to minimize the cost function. The iteration process is repeated until the cost function is minimized and the desired state is achieved. The number of iterations required to achieve the desired outcome depends on the complexity of the system and the accuracy of the predictions. For example, the computational resources available, the complexity of the driving environment, and the time constraints for decision-making will affect the number of iterations that can be run in real-time. The optimal number can be determined empirically by testing a particular vehicle under specific conditions and adjusting the iterations based on observed performance.

A Bird's Eye View (BEV) generation module is used in various configurations. For example, the output BEV costmap is sent to the path-planning module, which adjusts coefficients in its planning to optimize the trajectory based on the driving environment. A cost model is a representation of the environment in which the car is driving. In an embodiment, a cost model is used to calculate the cost of a trajectory, which is a path that the car could take. The cost of a trajectory is determined by a number of factors, including the distance traveled, the smoothness of the path, and the avoidance of obstacles.

An exemplary system integrates a BEV perception network with a path-planning controller and includes one or more camera sensors that capture a sequence of frames of a driving scene. A feature extractor is used to encode the frames into a feature vector. For example a convolutional-neural network (CNN) based feature extractor is used. A BEV generation module with transformer-based neural network architecture transforms the feature vector into a BEV costmap, using a deformable spatial cross-attention mechanism. The BEV generation module learns to associate the input features with the spatial positions on the track, and to generate a costmap that reflects the track layout, the track boundaries, the obstacles, and the optimal driving line. The BEV generation module does not require any external localization systems or pre-built maps, and can adapt to different track shapes and sizes. A path-planning controller uses the BEV costmap as the input and plans the optimal trajectory for the car, taking into account the predictive model of the car and its future states. The path-planning controller samples multiple possible trajectories, evaluates respective trajectory costs based on the costmap, and selects the best trajectory that minimizes the cost and maximizes the performance. The path-planning controller can handle the uncertainty and variability of the environment and the car dynamics, and can generate smooth and feasible trajectories. A vehicle agent executes the planned trajectory and updates its position. The vehicle agent receives the control commands from the controller, such as steering angle and throttle, and applies control commands to the car. The vehicle agent also updates its position based on the odometry information from the car sensors, and feeds back the updated position to the path-planning controller.

The system operates by tracking a queue of past camera frames. A slice of N past frames is encoded by the feature extractor and submitted to the BEV generation module. The BEV generation module cross-correlates the input features with spatial positions around the car and generates a top-down BEV costmap, which indicates the penalties or rewards for different locations on the track. The BEV costmap is then sent to the path-planning controller, which rolls out numerous possible trajectories, estimates their costs, and calculates the best trajectory from among the possible trajectories. The best trajectory is executed by the vehicle agent, which updates its position and the cycle repeats again with updated sensor information.

In an embodiment, the path integral is optimized using a Monte Carlo approximation. In an embodiment, a Monte Carlo approximation includes sampling a large number of trajectories from the uncontrolled dynamics of the system, and then computing the optimal control as the trajectory that minimizes the expected cost over all of the sampled trajectories. The main advantage of using a Monte Carlo approximation is that it allows the path integral to be optimized for systems with high-dimensional state spaces. This is because the Monte Carlo approximation does not require the state space to be discretized, which can be a significant advantage for systems with a large number of states. However, the main disadvantage of using a Monte Carlo approximation is that it can be computationally expensive. This is because the number of trajectories that need to be sampled in order to obtain a good approximation of the optimal control can be very large.

In an embodiment, all path calculations are performed locally on the autonomous vehicle. This helps avoid uncertainty and latency. Alternatively, some parts of the autonomous driving system are distributed. For example, portions of the calculations can be distributed across non-vehicle components, such as a base system operably coupled to the vehicle, or with other distributed components that are communicatively coupled to the vehicle, such as cloud-based components. In various embodiments, autonomous driving hardware, such as NVIDA drivepx platform or similar platforms are used. In various embodiments, camera sensors are used.

The state of a system comprising an autonomous vehicle can be represented by a state vector x. The state vector is a vector that contains information about the state of the system. The kth element of the state vector is represented as xx. The state vector contains information about the position, velocity, and acceleration of the autonomous vehicle. The kth element of the state vector is used to track the state of the system over time.

The path-planning controller acts on descriptions received as inputs. State vectors and BEV costmaps are both used as inputs for calculating cost coefficients. A state vector comprises a mathematical representation of the state of a system at a given time. A state vector includes a set of variables that describe the relevant aspects of the system, such as vehicle position, velocity, orientation, acceleration, etc. For example, a state vector for a car on a 2D plane could be [x, y, theta, v], where x and y are the coordinates of the car's center of mass, theta is the angle of the car's heading, and v is the velocity of the car. A state vector is useful for predicting the future behavior of a system, given the current state of the system and the inputs that affect the system.

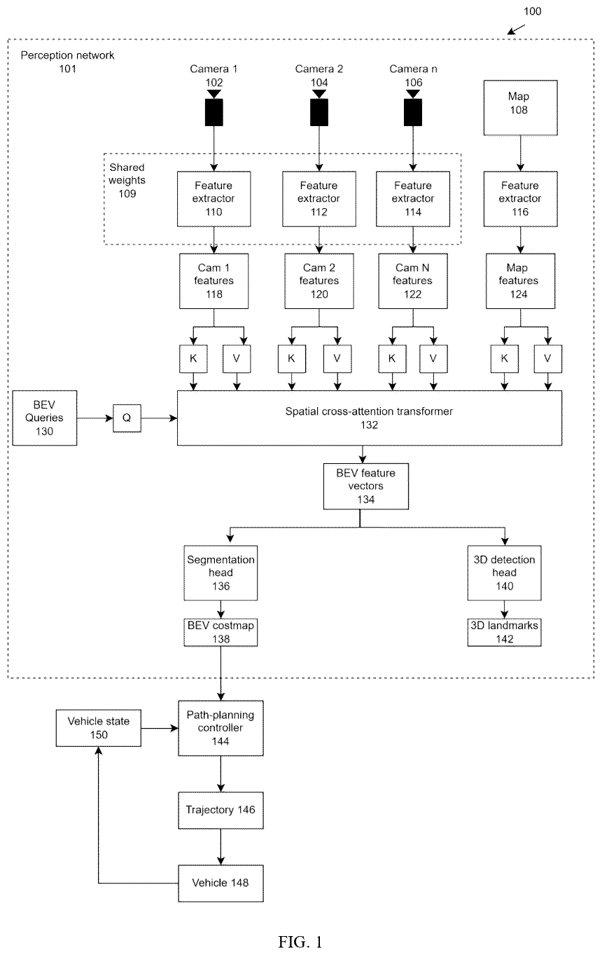

FIG. 1 is a block diagram of a system 100 comprising perception network 101. Though not depicted in FIG. 1, system 100 can comprise at least one microprocessor and operably coupled memory to implement the various components of system 100. Perception network 101 comprises n cameras labeled 1, 2, . . . n (102, 104, 106) and map 108. Cameras 1, 2, . . . n are coupled with corresponding feature extractors using shared weights 109. Feature extractors 110, 112, and 114 take camera image data as inputs and apply shared weights 109. Outside of shared weights 109, map 108 is coupled with feature extractor 116.

The output of camera feature extraction is represented as camera 1 features 118, camera 2 features 120, and camera n features 122. Map features 124 are extracted from features extractor 116. Extracted features are divided into key (K) and value (V) pairs.

BEV queries 130 comprising query (Q) are passed to spatial cross-attention transformer 132. Spatial cross-attention transformer 132 is a type of neural network architecture that incorporates attention mechanisms to selectively focus on different parts of spatial data. The spatial cross-attention transformer 132 incorporates attention mechanisms to selectively focus on different parts of spatial data. Input spatial data, such as camera images, are divided into smaller segments or patches. Each patch is encoded into a high-dimensional vector, which serves as the input token for spatial cross-attention transformer 132. A self-attention mechanism allows each patch to interact with every other patch. This is done by calculating attention scores that determine the importance of all other patches relative to a given patch. The scores are based on the similarity between patches. Attention scores are used to dynamically weight the input tokens. Patches that are deemed more important receive higher weights, allowing spatial cross-attention transformer 132 to focus on them more. Weighted features are aggregated to form a new representation of the input data, which emphasizes the most relevant parts. Multiple layers of attention mechanisms can be stacked, allowing spatial cross-attention transformer 132 to refine its focus iteratively and capture complex patterns in the data. The spatial cross-attention transformer 132 uses the aggregated features to output a feature vector.

After the final transformer layer, the model aggregates refined features into a single feature vector. This single feature vector encapsulates the essential information that the model has learned about the object or scene. This resulting feature vector can then be used for downstream tasks, such as path planning.

Accordingly, the output of spatial cross-attention transformer 132 are BEV feature vectors 134. BEV feature vectors 134 are passed to segmentation head 136 and BEV costmap 138. Segmentation head 136 is a component of a neural network that is responsible for dividing an image into segments, typically to identify and isolate different objects within the image. This process is known as image segmentation. The segmentation head 136 operates after the feature extraction phase (e.g. output of BEV feature vector 134 by spatial cross-attention transformer 132). The segmentation head 136 uses the extracted features to perform the segmentation task. The segmentation head 136 typically includes a series of convolutional layers, and sometimes deconvolutional layers, to process the feature maps and produce the segmented output.

Feature vectors 134 are also passed to 3D detection head 140 and 3D landmarks 142. The 3D detection head 140 refers to a component of a neural network configured to detect and localize objects in three dimensions from image data. Detecting and localizing involves not only recognizing the object but also determining the position and orientation of the object within the space. The 3D detection head 140 processes features extracted by the neural network and uses them to predict 3D bounding boxes around objects, which include dimensions and orientation, along with class labels. 3D landmarks refer generally to specific points in 3D space that are used to define the shape and location of an object. These 3D landmarks can be corners, edges, or any other distinctive features of an object. The 3D landmarks can be used to determine the size, orientation, and position of a bounding box in 3D space.

With reference to segmentation head 136 and 3D detection head 140, the head refers to the part of a neural network that is specifically configured to process the extracted features from the input data and perform the task of object detection in three dimensions. In this context, a head is typically the final part of the model that makes predictions based on the learned features. The head usually consists of several layers of the neural network that may include fully connected layers or convolutional layers.

Path-planning controller 144 receives BEV costmap 138 as its input. Costmap 138 is used by path-planning controller 144 to calculate trajectory 146, which is then passed to vehicle 148. The current vehicle state 150 is updated and re-fed to path-planning controller 144. Costmap 138 ensures safe and efficient navigation and may take a variety of forms. In an embodiment, grid-based costmaps represent the environment with cells indicating the presence of obstacles. Mathematical functions can be used to define the cost associated with any point in space. Costmap 138 can also incorporate risk and feasibility calculations based on lane and road boundaries. In an embodiment, costmap 138 separates different types of information, such as static and dynamic obstacles, into different layers. The layers are then combined to form a master costmap. For example, a static layer represents the static part of the environment, such as roadways and trees, that do not change over time. An obstacle layer represents dynamic obstacles detected by cameras, such as moving people or other vehicles. Each layer in the costmap can track one type of obstacle or constraint. The layers can be processed separately and then combined to form the final costmap used for navigation.

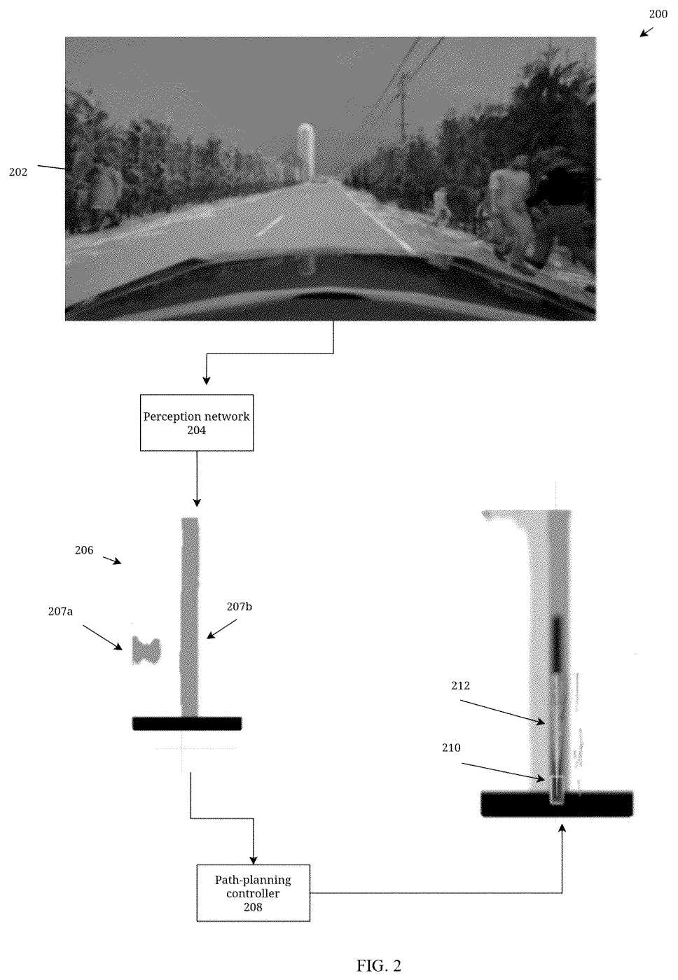

FIG. 2 shows a system 200 where image data 202 is passed through perception network 204 and represented as image 206, which shows a path including obstacle 207a and a driving path 207b. This image 206 is passed to path-planning controller 208, which uses the data on behalf of vehicle 210 to calculate possible trajectories 212.

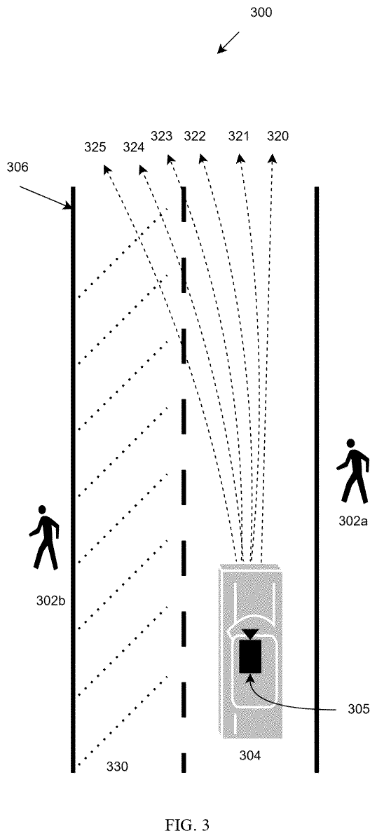

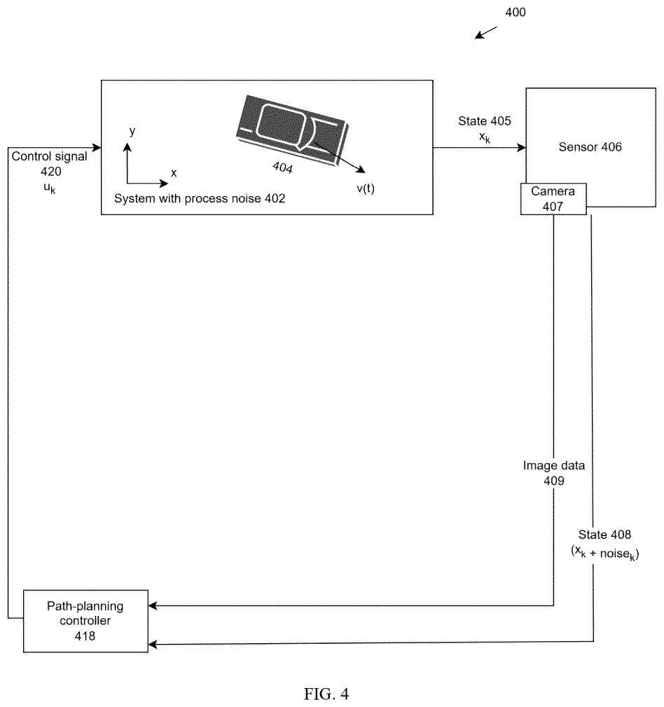

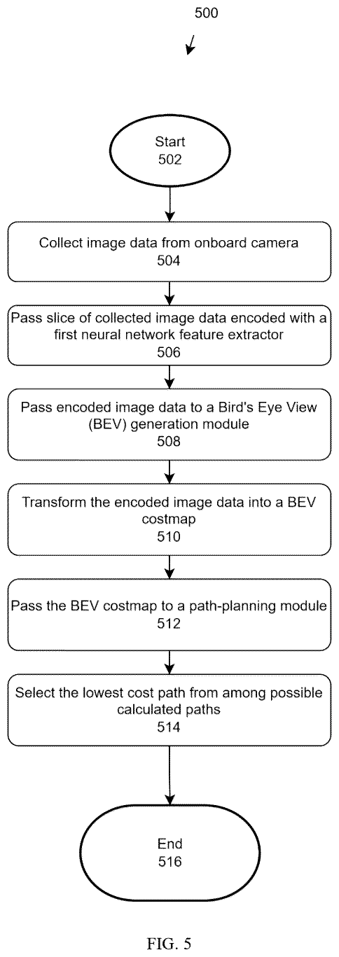

FIG. 3 shows an exemplary driving scenario 300. In this scenario, pedestrians 302a, 302b are near autonomous vehicle 304, which is equipped with camera 305. Camera image data detected or otherwise collected by camera 305 collects movements of pedestrians 302a, 302b, as well as the environment. Possible trajectories 320-325 through the environment are considered by the path-planning controller. Trajectories 320-325 represent possible paths for the autonomous vehicle. The system will choose the lowest cost path as explained in detail in connection with FIG. 4 and FIG. 5.

FIG. 4 shows a block diagram of an embodiment 400 where system 402 comprises autonomous vehicle 404, along with inherent process noise. The state of system 402 comprising autonomous vehicle 404 is represented by state vector x (405). State vector 405 is a vector that contains information about the state of system 402. The kth element of the state vector 405 is represented as xx. The state vector contains information about the position, velocity, and acceleration of autonomous vehicle 404. The kth element of the state vector is used to track the state of the system over time.

The state vector includes various variables defining the car's current status; for example, positional coordinates (x, y in 2D space), velocity (with directional components), linear and angular acceleration (indicating changes in velocity over time), orientation (described using angles like yaw, pitch, and roll), and angular velocity (the rate of angular position change). Additionally, control inputs such as steering angle, throttle, and brake can also be incorporated. The kth element of a vector is the cost of the kth rollout from a given time onward. For example, given a vector dxt with four elements, the first element would be the cost to go from time t₀ to t₁, the second element would be the cost to go from time t₁ to t₂, and so on. The kth rollout is the trajectory of the system starting from the initial state x(t0) and using the control input sequence u₀, u₁, . . . , uₖ₋₁.

Sensor 406 records state information such as position, velocity, and acceleration of autonomous vehicle 404. In an embodiment, sensor 406 represents several sensors, including camera 407. Camera 407 detects driving-scenario data, such as images along a path. In an embodiment, the path is a public or private roadway. The output of camera 407 is image data 409. Image data 409 is passed to feature extractor 410 for encoding before being passed to BEV module 418. BEV module 418 generates a BEV costmap, which is passed to path-planning controller 418. The output of sensor 406 is passed as state vector 408, which includes state vector 405 plus noise, to path-planning controller 418. State information for system 402 inherently includes some noise due to the nature of system 402. The state received by path-planning controller 418 is thus state 408, which refers to the system state vector 405 plus process noise inherent in system 408. Noise in this context is used to model uncertainty in the system dynamics, such as unmodeled forces or sensor noise. State vector 408 is an input for calculating cost coefficients.

FIG. 5 is a flowchart of a method 500 of path-planning operations for an autonomous vehicle according to an embodiment. Operations begin at 502. Image data is collected at 504 along the path of an autonomous vehicle with an onboard camera operably coupled to the autonomous vehicle. At 506, a slice of collected image data is passed and encoded with a first neural network feature extractor. In this context, slices of image data refer to a portion or segment of an image that is processor or analyzed. For example, slices can be specific areas of the road ahead, segments that include potential obstacles, or regions that need to be monitored for navigation and safety purposes. The encoded image data is passed to a Bird's Eye View (BEV) generation module at 508. The BEV module, which is a second neural network that cross-correlates input features with spatial positions around the autonomous vehicle, transforming the encoded image data into a BEV costmap at 510. The output, the BEV costmap, is passed to a path-planning module operably coupled to the autonomous vehicle at 512. The path-planning module, which is configured to calculate a plurality of possible paths using a cost model, selects at 514 the lowest cost path from among the possible calculated paths based on the cost assigned by the path-planning module.

1. A method for navigating a path by an autonomous vehicle in motion without using an external localization device, the method comprising:
collecting image data along the path with an onboard camera operably coupled to the autonomous vehicle in motion;
passing a slice of collected image data encoded with a first neural network feature extractor to generate encoded image data;
passing the encoded image data to a Bird's Eye View (BEV) generation module;
wherein the BEV generation module is a second neural network that cross-correlates input features with spatial positions around the autonomous vehicle;
transforming the encoded image data into a BEV costmap using the BEV generation module;
passing the outputted BEV costmap to a path-planning module operably coupled to the autonomous vehicle, wherein the path-planning module is configured to calculate a plurality of possible paths using a cost model; and
selecting, with the path-planning module, the lowest cost path from among the possible calculated paths.

2. The method of claim 1, wherein the first neural network is a convolutional neural network.

3. The method of claim 1, wherein the second neural network is a pre-trained transformer.

4. The method of claim 1, wherein the path-planning module is a Model Predictive Path Integral (MPPI) module.

5. The method of claim 1, wherein selecting the lowest cost path includes applying an optimizer using a Monte Carlo approximation.

6. The method of claim 1, wherein the second neural network is a spatial-cross attention transformer.

7. The method of claim 6, wherein the output of the spatial cross-attention transformer comprises a BEV feature vector.

8. A system for navigating a path by an autonomous vehicle in motion without using an external localization device, the system comprising:
an autonomous vehicle coupled with a plurality of onboard sensors for collecting image data;
a microprocessor coupled with a nontransitory storage medium communicatively coupled with the plurality of onboard sensors;
a first neural network comprising a feature extractor, under program control of the microprocessor, configured for encoding collected image data from the plurality of onboard sensors;
a Bird's Eye View (BEV) generation module, under program control of the microprocessor, wherein the BEV generation module is a second neural network configured to cross-correlate input features with spatial positions around the autonomous vehicle and wherein the BEV module is configured to transform the encoded collected image data into a BEV costmap;
a path-planning module, under program control of the microprocessor, configured to calculate a plurality of possible paths from the BEV costmap using a cost model, wherein the path-planning module is configured to select the lowest cost path from among the possible calculated paths.

9. The system of claim 8, wherein the first neural network is a convolutional neural network.

10. The system of claim 8, wherein the second neural network is a pre-trained transformer.

11. The system of claim 8, wherein the path-planning module is a Model Predictive Path Integral (MPPI) module.

12. The system of claim 8, wherein the second neural network is a spatial-cross attention transformer.

13. The system of claim 12, wherein the spatial cross-attention transformer is configured to output a BEV feature vector.

14. A method for navigating a path by an autonomous vehicle in motion without using an external localization device, the method comprising:
accessing image data collected on the path by an onboard sensor operably coupled to the autonomous vehicle;
passing a slice of collected image data encoded with a first neural network feature extractor to generate encoded image data;
passing the encoded image data to a Bird's Eye View (BEV) generation module;
wherein the BEV generation module is a second neural network that cross-correlates input features with spatial positions around the autonomous vehicle;
transforming the encoded image data into a BEV costmap using the BEV generation module;
passing the outputted BEV costmap to a path-planning module operably coupled to the autonomous vehicle, wherein the path-planning module is configured to calculate a plurality of possible paths using a cost model; and
selecting, with the path-planning module, the lowest cost path from among the possible calculated paths.

15. The method of claim 14, wherein the first neural network is a convolutional neural network.

16. The method of claim 14, wherein the second neural network is a pre-trained transformer.

17. The method of claim 14, wherein the path-planning module is a Model Predictive Path Integral (MPPI) module.

18. The method of claim 14, wherein the second neural network is a spatial-cross attention transformer.

19. The method of claim 18, wherein the spatial cross-attention transformer is configured to output a BEV feature vector.

20. The method of claim 19, wherein BEV feature vector is converted to a BEV costmap and passed to the path-planning controller.
